(19) United States
(12) Patent Application Publication
(10) Pub. No.: US 2026/0058081 A1
(43) Pub. Date: Feb. 26, 2026

(54) LUG WIRE INDICATOR OF A CIRCUIT BREAKER

(71) Applicant: Siemens Industry, Inc., Alpharetta, GA (US)

(72) Inventor: Brian McCoy, Lawrenceville, GA (US)

(73) Assignee: Siemens Industry, Inc., Alpharetta, GA (US)

(21) Appl. No.: 18/814,854

(22) Filed: Aug. 26, 2024

(51) Int. Cl. H01H 71/04; H01H 71/00; H01H 83/20

(52) U.S. Cl. CPC H01H 71/04; H01H 2071/006; H01H 83/20

(57) ABSTRACT

A residential circuit breaker is provided with a mechanism for showing proper installation of a wire to ensure that an installer/a contractor is aware that the wire has been fully inserted into a lug. The residential circuit breaker comprises a lug wire indicator, comprising: an indicator flag with an extension that is extended beyond a pivot of the indicator flag, and a return spring located below a lug and beyond the pivot such that the return spring is located “indirectly” behind the lug, and wherein the lug wire indicator provides a visual indication that a wire is inserted all the way into the lug before tightening a pressure screw.

### BACKGROUND

### 1. Field

Aspects of the present disclosure generally relate to a lug wire indicator of a Circuit Breaker.

### 2. Description of the Related Art

A typical arc fault circuit interrupter (AFCI)/ground fault circuit interrupter (GFCI) residential circuit breaker includes a mechanical and an electronic pole. A panel wire is to be inserted into a circuit breaker lug of a residential circuit breaker. However, the concern is if the panel wire is not fully inserted or only partially inserted into the circuit breaker lug. First, the installer/contractor may not fully insert the stripped end of the panel wire into a load lug during installation. The breakers are typically mounted horizontally and how much of the stripped end of the wire is inserted into the lug is unknow when the lug screw is tightened. Second, if the panel wire is not fully inserted in the lug, a lug screw could loosen over time and the panel wire could back out and just be touching the lug or the lug screw. While it may seem that the panel wire has been inserted into the load lug, this is unclear as there is no indicator for installer/contractor that the panel wire is fully inserted into a lug body.

Typical residential circuit breaker includes a load and/or a neutral lug with a lug screw. The circuit breaker lug(s) are designed to accept the panel wires and a lug body screw is provided to secure the connection between the panel wire and the circuit breaker lug.

The existing Residential Circuit breaker designs have several areas of concern. The assumption is that the installer/contractor will insert the panel wire fully into the lug body before tightening the lug body screw thus securing the connection. However, this may not be the case as the installer/contractor may not be aware if the panel wire is fully inserted or is only partially inserted into the lug body. The installer/contractor could install the panel wire but not fully insert it in the lug and tighten the lug screw. In this case, the tip of the panel wire that is stripped could be touching the lug body or screw providing temporary power and could result in an arcing connection, a thermal overload condition or a loss of power. In all three cases, a breaker handle could indicate On and/or Trip position.

Therefore, there is a need for a simplified means to show proper installation of a panel wire within a Residential Circuit Breaker.

### SUMMARY

Briefly described, aspects of the present disclosure relate to circuit breakers. This invention solves a problem where space is very limited behind the lug where the alternative would have been to increase the overall length of the breaker to accommodate the original design. This Lug Wire Indicator with an extension will allow lug wire indication without increasing the overall length of the circuit breaker by utilizing the space below the lug instead of behind the lug. This was needed because the envelope of some existing circuit breakers had already been established. This will also provide more flexibility while designing new products. This invention solves an issue of the high cost needed to modify existing circuit breaker designs by increasing the overall length to accommodate the space requirement behind the lug. Test fixtures, cardboard cartons and clamshells would also need to be redesigned. Using this pivot design requires only minimal internal changes inside the existing breaker envelope.

In accordance with one illustrative embodiment of the present disclosure, a lug wire indicator of a residential circuit breaker is provided. It comprises an indicator flag with an extension that is extended beyond a pivot of the indicator flag and a return spring located below a lug and beyond the pivot such that the return spring is located “indirectly” behind the lug. The lug wire indicator provides a visual indication that a wire is inserted all the way into the lug before tightening a pressure screw.

In accordance with one illustrative embodiment of the present disclosure, a method of providing an install indicator of a panel wire in a residential circuit breaker is provided. The method includes providing an indicator flag with an extension that is extended beyond a pivot of the indicator flag. The method further includes providing a return spring located below a lug and beyond the pivot such that the return spring is located “indirectly” behind the lug. The lug wire indicator provides a visual indication that a wire is inserted all the way into the lug before tightening a pressure screw.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates a view of a residential circuit breaker (RCB) with a lug wire indicator in accordance with an exemplary embodiment of the present disclosure.

FIG. 2 illustrates a zoomed-in view of a portion of the residential circuit breaker (RCB) of FIG. 1 showing the lug wire indicator in accordance with an exemplary embodiment of the present disclosure.

FIG. 3 illustrates a cross-sectional view, at section lines D-D of FIG. 1, of the visible position of the lug wire indicator of the residential circuit breaker (RCB) of FIG. 1 in accordance with an exemplary embodiment of the present disclosure.

FIG. 4 illustrates a cross-sectional view, at section lines D-D of FIG. 1, of the retracted position of the lug wire indicator of the residential circuit breaker (RCB) of FIG. 1 in accordance with an exemplary embodiment of the present disclosure.

FIG. 5 illustrates a schematic view of a flow chart of a method of providing a lug wire indicator of a panel wire in a residential circuit breaker in accordance with an exemplary embodiment of the present disclosure.

### DETAILED DESCRIPTION

Various technologies pertain to a lug wire indicator of a circuit breaker. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present disclosure, they are explained hereinafter with reference to implementation in illustrative embodiments. In particular, they are described in the context of an ability to provide a wire indicator near the lug area to ensure that a lug wire has been fully inserted into a circuit breaker lug. Embodiments of the present disclosure, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

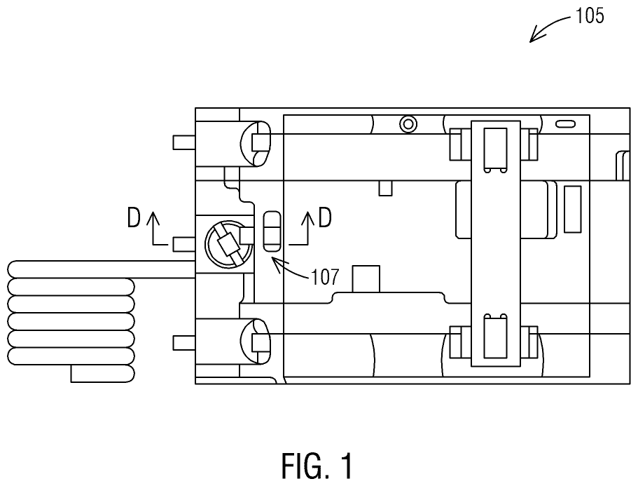

These and other embodiments of the Residential Circuit Breaker with a lug wire indicator according to the present disclosure are described below with reference to FIGS. 1-9 herein. Like reference numerals used in the drawings identify similar or identical elements throughout the several views. The drawings are not necessarily drawn to scale.

Consistent with one embodiment of the present disclosure, FIG. 1 represents a view of a residential circuit breaker (RCB) 105 in accordance with an exemplary embodiment of the present disclosure. FIG. 1 is a view of a two-pole electronic circuit breaker including a means to indicate proper lug wire insertion in a lug body in accordance with this invention. In particular, the residential circuit breaker (RCB) 105 includes a lug wire indicator 107. The lug wire indicator 107 to provide an indication about status of a lug wire (not shown) in a lug body (not seen) of a circuit breaker lug of the residential circuit breaker 105. The lug wire indicator 107 ensures that an installer/a contractor is aware that the lug wire has been fully inserted into the circuit breaker lug.

The residential circuit breaker 105 may be a two-pole electronic circuit breaker that consists of 3 modules—a left pole mechanical module, a right pole mechanical module and an electronic module. These modules include typical mechanism components that will close a moveable arm and a contact when a breaker handle is rotated to a fully ON position. Modules include a moveable arm and a contact, a stationary terminal and contacts, cradles, breaker handles, springs, armatures, bimetals, flexible copper braids, bases, and covers. These are typical mechanical components of a residential circuit breaker.

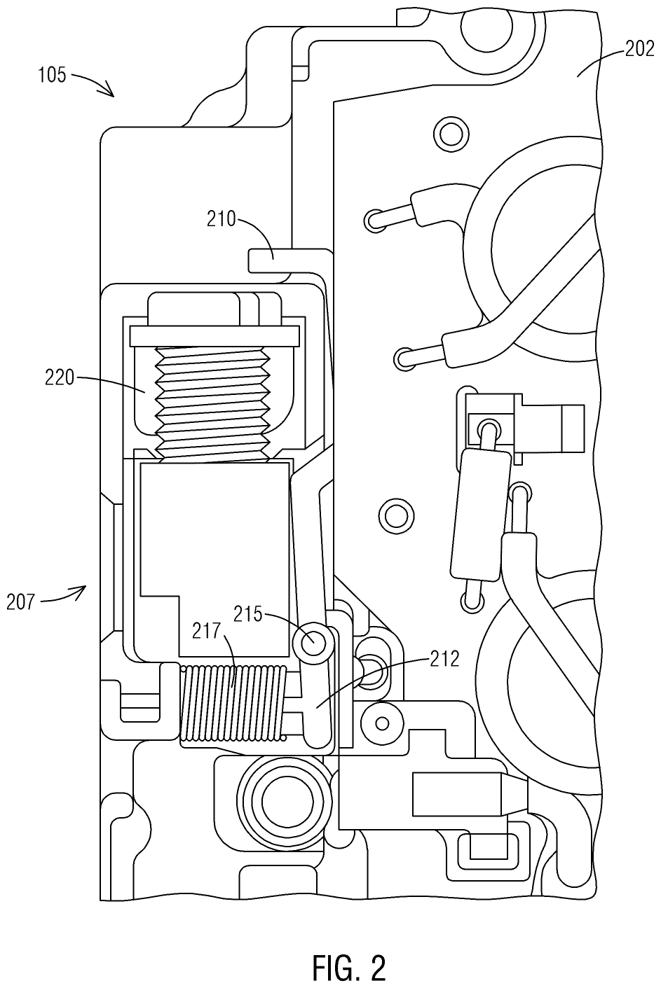

Referring to FIG. 2, it illustrates a zoomed-in view of a portion 202 of the residential circuit breaker (RCB) 105 of FIG. 1 in accordance with an exemplary embodiment of the present disclosure. The circuit breaker is a ground fault circuit interrupter (GFCI) being 2-pole, 15-30 A and phase 3.

The residential circuit breaker (RCB) 105 comprises a lug wire indicator 207 of a circuit breaker. The lug wire indicator 207 includes an indicator flag 210 with an extension 212 that is extended beyond a pivot 215 of the indicator flag 210. The lug wire indicator 207 further includes a return spring 217 located below a lug 220 and beyond the pivot 215 such that the return spring 217 is located “indirectly” behind the lug 220. The lug wire indicator 207 provides a visual indication that a wire is inserted all the way into the lug 220 before tightening a pressure screw.

The extension 212 allows a lug wire indication without increasing an overall length of the circuit breaker by utilizing a space below the lug instead of behind the lug 220. The lug wire indicator 207 has a structure that works even if an envelope of some existing circuit breakers had already been established. Use of a pivot configuration requires only minimal internal changes inside an existing breaker envelope. There is no room for the return spring 217 behind the lug 220.

There is a visible position of the indicator flag 210. There is a retracted position of the indicator flag 210. The indicator flag 210 includes a colored surface that is used to indicate that the wire has been installed properly.

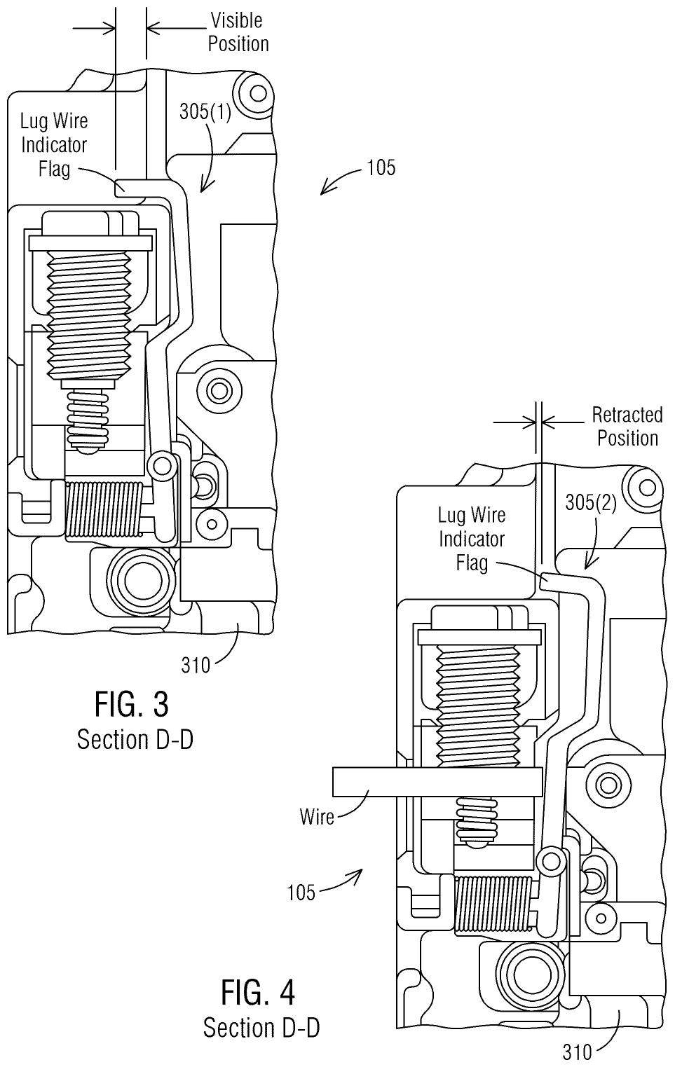

Turning now to FIG. 3, it illustrates a cross-sectional view of the visible position 305(1) of the lug wire indicator 310 of the residential circuit breaker (RCB) 105 of FIG. 1 in accordance with an exemplary embodiment of the present disclosure. FIG. 4 illustrates a cross-sectional view of the retracted position 305(2) of the lug wire indicator 310 of the residential circuit breaker (RCB) 105 of FIG. 1 in accordance with an exemplary embodiment of the present disclosure.

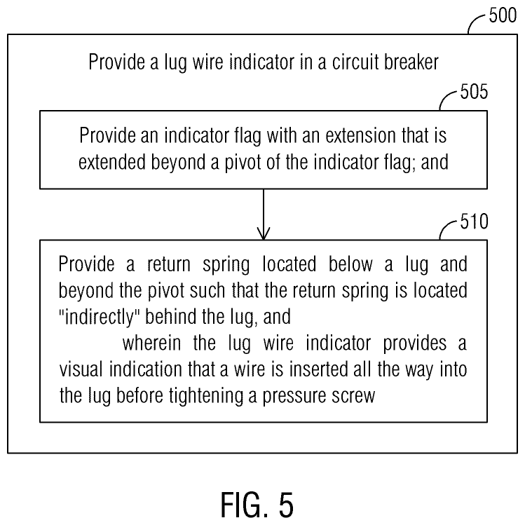

FIG. 5 illustrates a schematic view of a flow chart of a method 500 of providing the lug wire indicator 310 of a wire in the residential circuit breaker 105 in accordance with an exemplary embodiment of the present disclosure. Reference is made to the elements and features described in FIGS. 1-4. It should be appreciated that some steps are not required to be performed in any particular order, and that some steps are optional.

For providing the lug wire indicator 310 of the wire in the residential circuit breaker 105, the method 500 in step 505 provides an indicator flag with an extension that is extended beyond a pivot of the indicator flag. The method 500 further includes a step 510 of providing a return spring located below a lug and beyond the pivot such that the return spring is located “indirectly” behind the lug. The lug wire indicator 310 provides a visual indication that a wire is inserted all the way into the lug before tightening a pressure screw.

While a residential circuit breaker is described here a range of one or more other circuit breaker means or other forms of circuit breakers are also contemplated by the present disclosure. For example, other types of circuit breakers may be implemented based on one or more features presented above without deviating from the spirit of the present disclosure.

The techniques described herein can be particularly useful for the arc fault circuit interrupter (AFCI)/the ground-fault circuit interrupter (GFCI) indication. While particular embodiments are described in terms of an arc fault circuit interrupter (AFCI)/a ground-fault circuit interrupter (GFCI) indication, the techniques described herein are not limited to such a structure but can also be used with other electrical structures or configurations.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A lug wire indicator of a circuit breaker, comprising:
an indicator flag with an extension that is extended beyond a pivot of the indicator flag; and
a return spring located below a lug and beyond the pivot such that the return spring is located “indirectly” behind the lug, and
wherein the lug wire indicator provides a visual indication that a wire is inserted all the way into the lug before tightening a pressure screw.

2. The lug wire indicator of claim 1, wherein the extension allows a lug wire indication without increasing an overall length of the circuit breaker by utilizing a space below the lug instead of behind the lug.

3. The lug wire indicator of claim 1, wherein the lug wire indicator has a structure that works even if an envelope of some existing circuit breakers had already been established.

4. The lug wire indicator of claim 1, wherein use of this pivot configuration requires only minimal internal changes inside an existing breaker envelope.

5. The lug wire indicator of claim 1, wherein there is no room for the return spring behind the lug.

6. The lug wire indicator of claim 1, wherein there is a visible position of the indicator flag.

7. The lug wire indicator of claim 1, wherein there is a retracted position of the indicator flag.

8. The lug wire indicator of claim 1, wherein the indicator flag includes a colored surface that is used to indicate that the wire has been installed properly.

9. The lug wire indicator of claim 1, wherein the circuit breaker is a residential circuit breaker.

10. The lug wire indicator of claim 1, wherein the circuit breaker is a ground fault circuit interrupter (GFCI) being 2-pole, 15-30 A and phase 3.

11. A method of providing a lug wire indicator in a circuit breaker, the method comprising:
providing an indicator flag with an extension that is extended beyond a pivot of the indicator flag; and
providing a return spring located below a lug and beyond the pivot such that the return spring is located “indirectly” behind the lug, and
wherein the lug wire indicator provides a visual indication that a wire is inserted all the way into the lug before tightening a pressure screw.

12. The method of claim 11, wherein the extension allows a lug wire indication without increasing an overall length of the circuit breaker by utilizing a space below the lug instead of behind the lug.

13. The method of claim 11, wherein the lug wire indicator has a structure that works even if an envelope of some existing circuit breakers had already been established.

14. The method of claim 11, wherein use of this pivot configuration requires only minimal internal changes inside an existing breaker envelope.

15. The method of claim 11, wherein there is no room for the return spring behind the lug.

16. The method of claim 11, wherein there is a visible position of the indicator flag.

17. The method of claim 11, wherein there is a retracted position of the indicator flag.

18. The method of claim 11, wherein the indicator flag includes a colored surface that is used to indicate that the wire has been installed properly.

19. The method of claim 11, wherein the circuit breaker is a residential circuit breaker.

20. The method of claim 11, wherein the circuit breaker is a ground fault circuit interrupter (GFCI) being 2-pole, 15-30 A and phase 3.
